(19) United States
(12) Patent Application Publication
(10) Pub. No.: US 2023/0351374 A1
(43) Pub. Date: Nov. 2, 2023

(54) SYSTEM FOR ACCELERATED DISTRIBUTED LEDGER AND FOR DIGITAL WALLET DEPLOYMENT

(71) Applicant: Xeniro, Shanghai (CN)

(72) Inventors: En Shen Huang, Shanghai (CN); Liang Ma, Shanghai (CN)

(73) Assignee: Xeniro, Shanghai (CN)

(21) Appl. No.: 17/928,544

(22) PCT Filed: Jun. 11, 2020
(86) PCT No.: PCT/CN2020/095636

§ 371 Date: Nov. 29, 2022

(51) Int. Cl. G06Q 20/40; G06Q 20/38; G06Q 20/42

(52) U.S. Cl. CPC G06Q 20/3825; G06Q 20/3827; G06Q 20/3829; G06Q 20/401; G06Q 20/42

(57) ABSTRACT

A system for supporting services that uses a distributed ledger to record transaction data, the system comprising a block producing node comprising a processor arrangement configured to record a new data block into the distributed ledger, the processor arrangement configured to execute computer-readable program code to: receive a data package comprising transaction data for recording into a new data block of the distributed ledger, the data package bearing a signature arrangement, the signature arrangement being performed externally; validate the signature arrangement of the received data package; determine whether consensus is present through a sufficient number of other block producing nodes in the system having also received the data package and validated its signature arrangement; and record the transaction data from the received data package into a new data block of the distributed ledger, in response to confirmation of the consensus being present.

### FIELD

Herein disclosed is a system that accelerates the updating of a distributed ledger. Also disclosed is means to facilitate embedding a digital wallet in an IoT device for use with a mobile network operator.

### BACKGROUND

Decentralised ledger technology has attracted much interest in recent years due to its flexibility of applications: from providing an architecture for utility tokens that can be used to deploy built-in smart contracts.

However, block chain backed transactions suffer from several limitations. Current market distributed ledger solutions (e.g. EOS) request all tasks that are in relation to recording a new data block into a distributed ledger to be completed within one server with X86 CPU. This server easily becomes a bottleneck due to CPU performance and node to node network latency.

In addition, adoption of current market distributed ledger solutions for mobile network operators is inefficient due to the hierarchical architecture of their networks.

The present invention seeks to addresses the above shortcomings and deliver a system that harnesses block chain technology more effectively, for example through a mobile operator’s distributed edge infrastructure.

### SUMMARY OF THE INVENTION

According to a first aspect of the invention, there is provided a system for supporting services that use a distributed ledger to record transaction data, the system comprising a block producing node comprising a processor arrangement configured to record a new data block into the distributed ledger, the processor arrangement configured to execute computer-readable program code to: receive a data package comprising transaction data for recording into a new data block of the distributed ledger, the data package bearing a signature arrangement, the signature arrangement being performed externally; validate the signature arrangement of the received data package; determine whether consensus is present through a sufficient number of other block producing nodes in the system having also received the data package and validated its signature arrangement; and record the transaction data from the received data package into a new data block of the distributed ledger, in response to confirmation of the consensus being present.

According to a second aspect of the invention, there is provided a wireless device for use in a cellular communication network, the wireless device comprising: a transceiver; a secure element; and a processor in communication with the transceiver and the secure element, the processor configured to: store a key pair, based on a subscriber identity used to identify the wireless device to a mobile network operator network, in a secure element; generate a signature, using a private key of the key pair, for use with outgoing data; and transmit, via the transceiver, the outgoing data bearing the signature.

According to a third aspect of the invention, there is provided a service deployment server configured to transmit instructions, that when executed in a wireless device, configure the wireless device to: store a key pair, based on a subscriber identity used to identify the wireless device to a mobile network operator network, in a secure element of the wireless device; and generate a signature, using a private key of the key pair, for use with outgoing data for transmission.

According to a fourth aspect of the invention, there is provided a computer-readable, non-transitory medium storing a computer program, wherein said computer program causes a processor to execute: storing a key pair, based on a subscriber identity used to identify the wireless device to a mobile network operator network, in a secure element of the wireless device; and generate a signature, using a private key of the key pair, for use with outgoing data for transmission.

### BRIEF DESCRIPTION OF THE DRAWINGS

Representative embodiments of the present invention are herein described, by way of example only, with reference to the accompanying drawings, wherein:

FIG. 1 shows a schematic of a system which implements a distributed ledger accessed through a SaaS (software as a service) management console.

FIG. 2 shows a schematic overview of the operation of the system of FIG. 1.

FIG. 3 shows a schematic of the operation of a block producing node of FIG. 2.

FIG. 4 illustrates operation of acceleration nodes of FIG. 2 under a first scenario.

FIG. 5 illustrates operation of acceleration nodes of FIG. 2 under a second scenario.

FIGS. 6 and 7 each shows a schematic of verify and commit processes performed by an acceleration node of FIG. 2.

FIG. 8 shows a schematic summarising the functions performed by API nodes; acceleration nodes; and the block producing node of FIG. 2 when creating a new data block in a distributed ledger.

FIG. 9 illustrates use of a container based service to upgrade or reprogram an acceleration node.

FIG. 10 shows the system of FIG. 2 being deployed in accordance with BFT (Byzantine fault tolerance).

FIG. 11 is a schematic providing an overview of management consoles facilitating the deployment of an electronic subscriber identity module (eSIM) in different mobile network operators (MNO).

FIG. 12 shows remote configuration of an eSIM using a service deployment server.

FIG. 13 shows a sequence of stages that occur when provisioning a secure element using a service deployment server that belongs to a MNO.

FIG. 14 shows a chart that depicts Round Trip Time (RRT) latency times for a server equipment room, an edge data center, a central office, a core network, a regional data centre and a global data centre.

### DETAILED DESCRIPTION

In the following description, various embodiments are described with reference to the drawings, where like reference characters generally refer to the same parts throughout the different views.

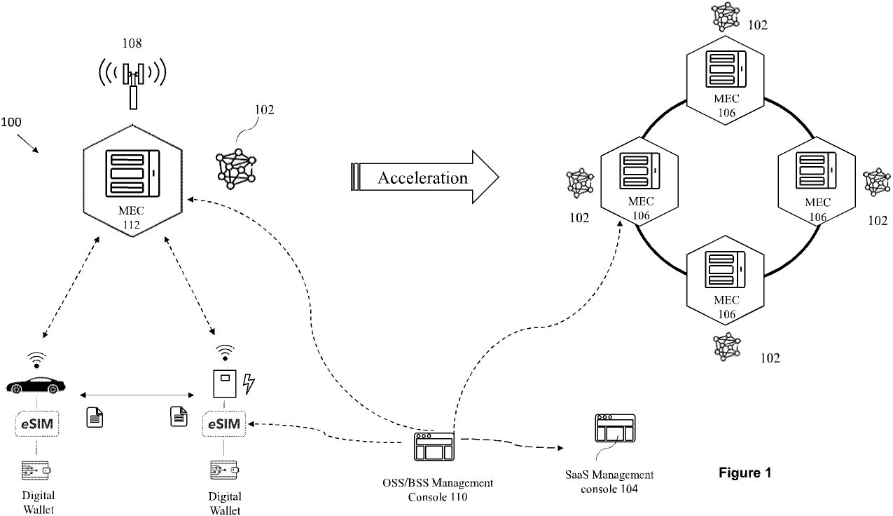

FIG. 1 shows a schematic of a system 100 which implements a distributed ledger (DLT) 102 accessed through a SaaS (software as a service) management console 104. The DLT 102 is maintained at multi-access edge computing (MEC) nodes 106. Each multi-access edge computing node 106 is located within a cellular coverage area supported by a base station 108 of a mobile network operator, such as being adjacent to the base station 108 or hosted in a mini data center / central office setting. The mobile network operator refers to any telecommunication company owning the rights to broadcast within an allocated frequency spectrum, with the base station providing the infrastructure to create a cell in a cellular network. Accordingly, the base station allows the mobile network operator to have wireless data communication over the allocated frequency spectrum and also a gateway to the core network serviced by the base station, the core network being part of interconnected computer systems, such as the Internet.

The multi-access edge computing node 106 is in proximity to the base station 108 or connected to a mini data centre or central office.

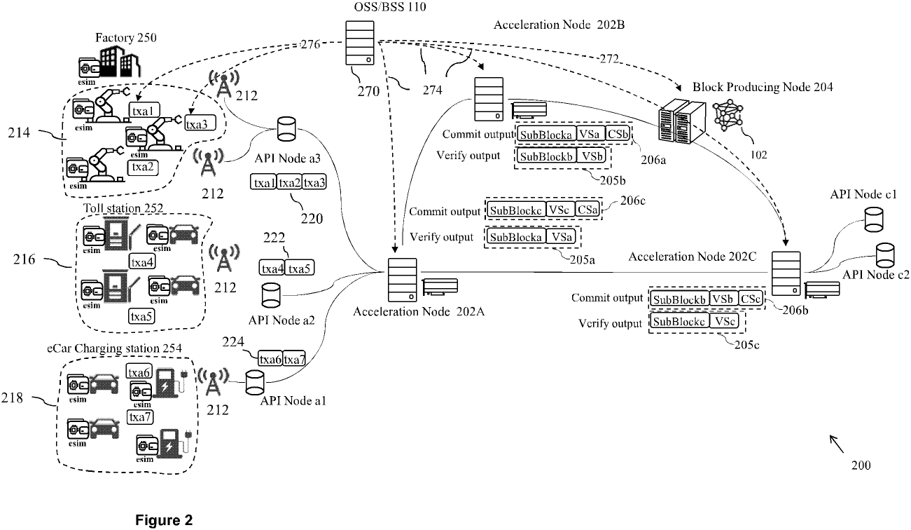

The distributed ledger 102 is a database storing records of entries of monitored transactions, with each of the multi-access edge computing nodes 106 hosting a replicate. In the context of IoT applications, a transaction may be automatically initiated by IoT devices themselves (i.e. machine to machine or M2M), provided certain conditions are met; or may require human intervention, such as an operator working an IoT device at one end (machine to human or M2H) or an operator working an IoT device at each end (human to human, H2H). The distributed ledger 102 essentially stores a chained data block which records a transfer of ownership during transactions from the first to the most recent, so that the chained data block provides a shared ledger function. Its data structure is a hash pointer to back-linked blocks of transactions. Each block is identifiable by a hash, with the hash referencing a previous block. The distributed ledger 102 is also synchronised in that when one of them is updated to record data of a new transaction into past transaction data, its hosting multi-access edge computing node 106 checks whether the updated ledger is in consensus with ledgers hosted in other multi-access edge computing nodes 106, updated with data of the same new transaction. Machine to machine validation is achieved when at least a majority of the other multi-access edge computing nodes 106 are in agreement with the updated ledger. In contrast to conventional distributed ledgers which is a result of block producing nodes validating the signature from other block producing nodes in respect of work done on their output data block, the distributed ledger 102 results from a block producing node reaching consensus of receiving a data block having sufficient signatures which are performed externally. The consensus used in the distributed ledger 102 is described in greater detail with reference to FIGS. 2 to 7.

The SaaS management console 104 is a cloud based software that allows enterprises to deploy all IoT related services via the DLT 102. The SaaS management console 104 acts as a proxy between enterprises and mobile operators network infrastructure, that is connected via an application programming interface (API) to a mobile network operators OSS (Operation Support System) & BSS (Business Support System) management console 110. Thereby services can be initiated, configured and processed seamlessly through their network infrastructure.

The functions of the SaaS management console 104 include the ability for enterprises to:
provide AML (anti money laundering) / KYC (know your client) validation via an API with both mobile network operator and banking regulators
remotely deploy, activate and automate services that are facilitated by eSIM (electronic subscriber identification module) technology, e.g. digital wallets, for enterprise IoT devices
performance acceleration & added security services through use of designated processors, e.g. FPGA (field programmable gate array) / ASIC (application-specific integrated circuit) chips in the MEC nodes 106. The performance acceleration is explained in greater detail below.
billing in tokens / points that can be converted to fiats (USD$, Eur, RMB... etc) or vice versa
deployment right at the edge of the network (orchestrate & manage applications (Apps) & decentralized applications/distributed ledger applications (DApps)) through MEC nodes (selection of required Compute, Storage, Networking resources) with a choice of geographical locations
creation of smart contract templates & deployment of smart contract for IoT devices for various industries. A smart contract refers to a digital contract, which is a contract whose terms and conditions are programmed into computer code, stored and replicated across the distributed ledger 102.
development tools for building DApps, smart contracts, plugins, API integration, SDK downloads, integrating existing Apps
track & trace history of smart contract transactions on the DLT 102 allowing (Data computation, Predictive Analytics, Audit trail) for generating reports
create a market place to buy, sell and exchange services that runs on the DLT 102

The OSS/BSS (Operations Support System / Business Support System) management console 110 for a MNO (mobile network operator) facilitates a service framework to maintain network operations. A non-exhaustive list of functions of the OSS/BSS management console 110 includes:
management & deployment of services (static registry, dynamic registry, smart contracts, payment transactions, billing of any Blockchain as a service, etc) that utilises the DLT 102
management & deployment of the mobile network operator MEC nodes
management & deployment of DApp/App (e.g. deploy/upgrade/ patch)
management & deployment of eSIMs
management & deployment of edge cloud services for enterprise IaaS (infrastructure as a service), PaaS (platform as a service) or SaaS

From FIG. 1, it will be appreciated that mobile network operators MEC (x86 server) architecture includes edge cloud services for IoT or enterprise solutions. Their MEC nodes (106, 112) provide compute, storage and networking capabilities. All MEC nodes (106, 112) have CPUs, but some may include GPU (graphic processing unit) or FPGA chips to process computational intensive services. CPUs are designed for multi-purpose workloads. If their CPUs are overloaded, specific DLT tasks can be offloaded onto their GPU or FPGA firmware. This frees up the CPU workload capacity improving both cost and efficiency. This utilization results in the required processing to record a new data block into the DLT 102 being distributed over several designated MEC nodes 106. These designated MEC nodes 106, which are called acceleration nodes, perform aggregation of the transaction data that each of the acceleration nodes processes. In this data aggregation, similar tasks are grouped. Parallel computing capability (e.g. through the use of on-board FPGA, ASIC or GPU) in each of these acceleration nodes is then harnessed to process the grouped tasks so as to improve service processing throughput (TPS). The tasks for which each of these acceleration nodes is responsible can be dynamically allocated, while applications running inside the acceleration nodes can be remotely upgraded, for example through a software update. The acceleration capability, along with recordation of a new data block into the DLT 102, is explained in greater detail with respect to FIGS. 2 to 7.

FIG. 2 shows a schematic of a system 200 for supporting services that uses a distributed ledger to record transaction data.

The system 200 has a block producing node 204 that is in communication with acceleration nodes 202A, 202B and 202C. Each of the acceleration nodes 202A, 202B and 202C is in turn in communication with API nodes, although only the API nodes a1, a2 and a3 that are in communication with the acceleration node 202A and the API nodes c1, c2 that are in communication with the acceleration node 202C are shown.

The distributed ledger used in the system 200 is the distributed ledger 102 of FIG. 1, which is accessed through the OSS/BSS 110. The OSS/BSS 110 is hosted on a management node 270. The management node 270 has a processor arrangement that is configured to execute computer-readable program code to: support one or more consoles providing the OSS/BSS 110 to host commands that manage operation of the distributed ledger 102; and transmit 272 the commands to the block producing node 204 for execution. The OSS/BSS 110 may also be used to transmit 274 commands that control the operation of the acceleration nodes 202A, 202B and 202C. In addition, as mentioned above, the OSS/BSS 110 provides an interface for enterprise clients operating IOT devices to query the distributed ledger 102. As an alternative to hosting the OSS/BSS 110 in a dedicated terminal, the OSS/BSS 110 may be hosted in the block producing node 204, where the block producing node 204 may support one or more consoles providing the OSS/BSS 110 that host commands that manage operation of the distributed ledger 102.

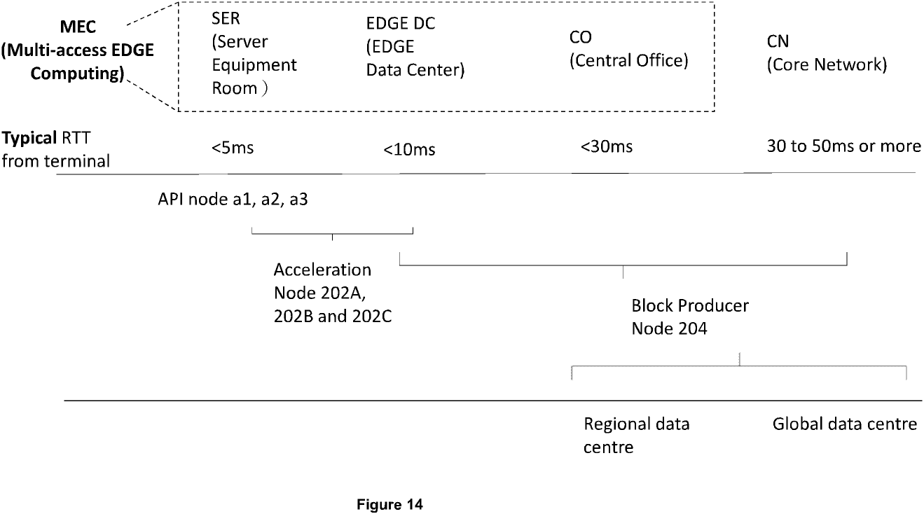

The role of the block producing node 204 is to generate blocks in the distributed ledger 102. In one implementation, the block producing node 204 is deployed in a location that is not limited to: an edge data center, a central office, a core network, a regional data centre or a global data centre. As shown in FIG. 14, the Round Trip Time (RRT) latency of the edge data center from a wireless terminal access point is around 5 to 10 ms. The RRT latency of the central office and the regional data centre from a wireless terminal access point is around 10 to 30 ms. The RRT latency of the core network and the global data centre from a wireless terminal access point is around 30 to 50 ms. Although only one block producing node 204 is shown in FIG. 2, their total number is decided by the consensus algorithm used to record a new data block into the distributed ledger 102. For example, if BFT (Byzantine fault tolerance) is adopted, the block producing node 204 is deployed in multiples of three. It will be appreciated that other consensus algorithms are possible.

The block producing node 204 has a processor arrangement that is configured to record a new data block into the distributed ledger 102. A suitable processor arrangement includes a central processing unit (CPU) formed by a single processor or a set of processors that perform the necessary arithmetic and logic operations to execute coding instructions, the coding instructions being in respect of management of the distributed ledger 102. The processor arrangement may thus be a stock processor as per standard technical specifications of a multi-access edge computing node. The processor arrangement may also include a dedicated processor configured with logic partitions that are catered for data block deployment into the distributed ledger 102. It will be appreciated that any mention of the block producing node 204 generally refers to the operation of its processor arrangement.

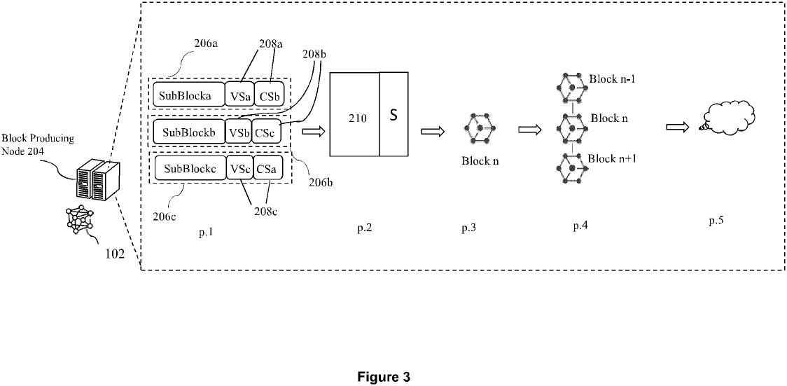

An operation sequence of the block producing node 204 upon receipt of a data package 206a is described below. It will be appreciated that a similar operation sequence applies when the block producing node 204 receives data packages 206b or 206c. Referring to both FIGS. 2 and 3, the block producing node 204 is configured to receive a data package 206a comprising transaction data SubBlocka for recording into a new data block of the distributed ledger 102. That is, the transaction data SubBlocka eventually becomes content of a new data block of the distributed ledger 102. Further content of a new data block could include other transaction data, such as SubBlockb and SubBlockc from their respective data packages 206b and 206c.

The block producing node 204 analyses whether the data package 206a bears a signature arrangement 208a of the transaction data SubBlocka. While FIG. 3 shows that the signature arrangement 208a is appended to the transaction data SubBlocka, it could also present in another location of the data package 206a as, for example, a packet header.

The detection of such a signature arrangement 208a notifies the block producing node 204 that the transaction data SubBlocka has already been pre-processed by one or more external nodes (such as one or more of the acceleration nodes 202A, 202B and 202C of FIG. 2), where this external pre-processing organises the transaction data SubBlocka into a format that is compatible for entry into the distributed ledger 102. The compatible format indicates that the transaction data SubBlocka in the received data package 206a has undergone one or more of the following processes: hashing through an algorithm used by the distributed ledger 102; rearrangement into a layout used by the distributed ledger 102; and authentication to a level required by the distributed ledger 102 (such as identification of the nodes that have processed the data package 206a). Transaction data SubBlocka being in a compatible format results in a data structure that is readily adopted by the distributed ledger 102. Such a data structure is achieved as a result of data aggregation being performed that results in the transaction data SubBlocka being awarded the signature arrangement 208a. The data aggregation, performed by one or more of the acceleration nodes 202A, 202B and 202C, sees similar tasks being grouped for processing. This data aggregation is described in greater detail later, in conjunction with the operation of the acceleration nodes 202A, 202B and 202C.

Having the transaction data SubBlocka being pre-processed by one or more external nodes is advantageous because their corresponding tasks which the block producing node 204 would otherwise have to perform are bypassed. For instance, the block producing node 204 is not required to hash each string of transaction data present in a new data block or group transaction data into subblocks, thereby alleviating the computationally intensive steps required should the block producing node 204 have to perform such hashing and collation.

The block producing node 204 also validates (refer p.1 of FIG. 3) the signature arrangement 208a borne by the received data package 206a. Such validation is performed because the block producing node 204 is in communication with one or more of the acceleration nodes 202A, 202B and 202C and monitors their output. If the signature arrangement 208a requires two signatures to be present (a verify signature VSa and a commit signature CSb), the validation that the block producing node 204 performs is to check whether both of the signatures VSa and CSb are present. Under such a validation procedure, a data package output by one or more of the acceleration nodes 202A, 202B and 202C that only bears the verify signature VSa (i.e. the commit signature CSb is absent) will fail the validation performed by the block producing node 204, so that the block producing node 204 will disregard such a data package. If a data package output by one or more of the acceleration nodes 202A, 202B and 202C bears both the signatures VSa and CSb (i.e. such as data package 206a), then signature arrangement 208a is successfully validated. As such the validation performed by the block producing node 204 in respect of the signature arrangement 208a depends on: i) the criteria that the distributed ledger 102 imposes on the signature arrangement 208a; ii) the processing performed by external nodes (such as the one or more of the acceleration nodes 202A, 202B and 202C) when awarding the signature arrangement 208a onto their output transaction data; or both. In a broad overview, each of the verify signature VSa, VSb, VSc and the commit signature CSa, CSb and CSc reflects a measurement of trust conferred onto their respective transaction data SubBlocka, SubBlockb and SubBlockc. The verify signature and the commit signature are described in greater detail later, in conjunction with the operation of the acceleration nodes 202A, 202B and 202C.

Following successful validation of the signature arrangement 208a at p.1 of FIG. 3, the block producing node 204 determines whether consensus is present, amongst other block producing nodes in the system 200. Such consensus is determined from the block producing node 204 enquiring with other block producing nodes in the system 200 whether a sufficient number of them are in receipt of the data package 206a and have validated the signature arrangement 208a of the data package 206a in the same manner as the block producing node 204. The transaction data SubBlocka is then recorded into a new data block of the distributed ledger 102, in response to confirmation of the consensus being present. With transaction data in a format adopted by the distributed ledger 102 circulating when determining consensus, a standardised protocol is used to process the transaction data in that the block producing nodes follow a similar set of processing tasks to perform the consensus. Redundant tasks, such as having to organise the transaction data SubBlocka into a correct sequence, are avoided.

One possible approach used by the block producing nodes to perform consensus and record a new data block in the distributed ledger 102 is described in greater detail with reference to p.2 to p.5.

The block producing node 204 (refer p.2) generates a data packet 210 that includes successfully validated data packages 206a, 206b and 206c (including their respective verify signatures VSa, VSb, VSc and commit signatures CSa, CSb and CSc). Optionally, the block producing node 204 is configured to include transaction data from a last data package when recording a new data block into the distributed ledger, the last data package being the most recently received data package with both a verify signature and a commit signature. The block producing node 204 will then attached its signature S to the data packet 210. The resulting data block (refer Block n at p.3) will be broadcast for consensus with other block producing nodes.

The other block producing nodes will also perform the same validation procedure done by the block producing node 204 (described above with respect to p.1) on their respectively received data packages. If a sufficient number of the other block producing nodes also obtains the same data packet 210, consensus between the block producing node 204 and the other block producing nodes is achieved. In various embodiments, a sufficient number refers to 66.7%. Block n is then recorded into the distributed ledger 102. A new data block (Block n+1, refer p.4) can then be recorded after Block n.

At p.5, any one of the block producing nodes involved in determining consensus broadcasts the update on the distributed ledger 102 over the system 200, which is received by other block producing nodes and the acceleration nodes 202A, 202B and 202C.

The signature arrangement 208a, 208b and 208c borne by each of the respective data packages 206a, 206b and 206c is performed externally, i.e. they are not done by the block producing node 204. The signature arrangement 208a, 208b and 208c results from the transaction data SubBlocka, SubBlockb and SubBlockc each having been consecutively signed. The consecutive signature performed on each transaction data SubBlocka, SubBlockb and SubBlockc is performed by a different external node. Returning to FIG. 2, the external nodes that are suitable to perform this consecutive verification are the acceleration nodes 202A, 202B and 202C.

The role of the acceleration nodes 202A, 202B and 202C is to accelerate the distributed ledger 102 by taking on a portion of the processing work required to record a new data block into the distributed ledger 102. Each of the acceleration nodes 202A, 202B and 202C is connected to at least one API node, with FIG. 2 only showing the API nodes a1, a2 and a3 that are connected to the acceleration node 202A and the API nodes c1, c2 that are connected to the acceleration node 202C. In one implementation, each of the acceleration nodes 202A, 202B and 202C is deployed in a location that is not limited to: a server equipment room or an edge data centre. As shown in FIG. 14, the Round Trip Time (RRT) latency of the server equipment room from a wireless terminal access point is less than 5 ms. The RRT latency of the edge data centre from a wireless terminal access point is around 5 to 10 ms. While not shown, the acceleration nodes 202A, 202B and 202C may also be deployed in a central office, a regional data centre or a global data centre. The RRT latency of the central office and the regional data centre from a wireless terminal access point is around 10 to 30 ms. The RRT latency of the core network and the global data centre from a wireless terminal access point is around 30 to 50 ms.

The total number of acceleration nodes connected to the block producing node 204 is decided by the consensus algorithm used to record a new data block into the distributed ledger 102. For example, if BFT (Byzantine fault tolerance) is adopted, the acceleration nodes 202A, 202B and 202C are deployed in multiples of three, as shown in FIG. 2. It will be appreciated that other consensus algorithms are possible.

Each of the acceleration nodes 202A, 202B and 202C has a processor arrangement that is configured to format transaction data for recording as a new data block into the distributed ledger 102. A suitable processor arrangement includes a central processing unit (CPU) formed by a single processor or a set of processors that perform the necessary arithmetic and logic operations to execute coding instructions, the coding instructions being in respect of formatting transaction data for recording as a new data block into the distributed ledger 102. The processor arrangement may thus be a stock processor as per standard technical specifications of a multi-access edge computing node. The processor arrangement may also include a dedicated processor (for example, a FPGA or an ASIC chip; or a GPU) configured with logic partitions that are catered to perform specific tasks so as to improve service processing throughput (TPS). It will be appreciated that any mention of the acceleration nodes 202A, 202B and 202C generally refers to the operation of its processor arrangement.

Two features in each of the acceleration nodes 202A, 202B and 202C facilitate their role of accelerating the distributed ledger 102 maintained by the block producing node 204. The first feature has each of the acceleration nodes 202A, 202B and 202C verifying their received transaction data. During this verification, the acceleration nodes 202A, 202B and 202C group transaction data according to the processing required to format them for compatibility with the distributed ledger 102. Parallel computing capability is then harnessed to process the grouped transaction data. The second feature has one of the acceleration nodes 202A, 202B and 202C validate the verification results of another of the acceleration nodes 202A, 202B and 202C. During this validation, one of the acceleration nodes 202A, 202B and 202C cross checks the results of the verification the other of the acceleration nodes 202A, 202B and 202C performs on its received transaction data. This validation is performed to establish trust since the ledger 102 is distributed and there is no central authority to decide whether a ledger record in any participant in the system 200 is correct.

Operation of the acceleration node 202A in respect of the first feature is described below. It will be appreciated that the other acceleration nodes 202B and 202C operate in respect of this first feature in a similar manner.

The acceleration node 202A receives transaction data (txa1 to txa7), eventually recorded as a new data block into the distributed ledger 102 by the block producing node 204, from the API nodes a1, a2 and a3.

The role of the API node a1, a2 and a3 is to collect the transaction data (txa1 to txa7), for example from IOT devices that operate in locations such as a factory 250, a toll station 252 and a charging station 254. The transaction data (txa1 to txa7) will be signed if they result from transactions performed by IOT devices with signature generation capability, such as by being provided with an eSIM (electronic subscriber identity module). However, the API nodes a1, a2 and a3 are also able to support transaction data (txa1 to txa7) resulting from IOT devices without signature generation capability.

The API nodes a1, a2 and a3 pre-process their collected transaction data (txa1 to txa7). In one implementation, the pre-processing performed includes: collating the transaction data (txa1 to txa7) into data packages 220, 222 and 224; ensuring data integrity exists in the data packages 220, 222 and 224 (such as being free of communication errors); generating a hash digest for each of the data packages 220, 222 and 224; and optionally applying its digital signature on its respectively created data packages 220, 222 and 224. The acceleration node 202A checks the hash to confirm the data packages 220, 222 and 224 integrity and the digital signature of the API node a1, a2 and a3, both of which is described later. In one implementation, the API node a1, a2 and a3 is deployed in a server equipment room, although other locations are possible. As shown in FIG. 14, the Round Trip Time (RRT) latency of the server equipment room from a wireless terminal access point is less than 5 ms. Each API node a1, a2 and a3 is connected to at least one 5G radio access point 212, through which each obtains the transaction data (txa1 to txa7). This keeps timing latency between IoT devices 214, 216 and 218, that transmit the transaction data (txa1 to txa7) and the API node a1, a2 and a3 as short as possible. In contrast to the block producing node 204 and the acceleration nodes 202A, 202B and 202C, there is no limitation on the number of API nodes a1, a2 and a3.

The acceleration node 202A extracts the transaction data (txa1 to txa7) from the data packages 220, 222 and 224 transmitted by the API nodes a1, a2 and a3. The acceleration node 202A then organises the received transaction data (txa1 to txa7) according to tasks required to process them. For instance if the transaction data (txa1 to txa7) is any one or more of data relating to: digital signatures providing transaction data immutability and undeniability of sender identity, smart contract execution and zero knowledge proof (ZKP), the acceleration node 202A organises the data requiring tasks that process digital signatures into a first group; the data requiring tasks that process smart contract execution into a second group; and the data requiring tasks that process ZKP into a third group. This is because the tasks that the acceleration node 202A performs in order to process each of these group of data require a sequence of steps that is specific to the format of the data in each of the three groups.

The acceleration node 202A assigns the organised transaction data (i.e. the transaction data (txa1 to txa7) that has undergone such organisation) to a designated partition of its processor arrangement configured to execute steps that are required to perform the required processing tasks. Each of these designated partitions refers to a logic partition of the processor arrangement of the acceleration node 202A that is catered to perform specific tasks so as to improve service processing throughput (TPS).

With reference to the data packages 206a, 206b and 206c described above in FIG. 3, examples of the tasks that the designated partitions of the processor arrangement are configured to execute include those that lead to the generation of the verify signature VSa, VSb, VSc and the commit signature CSa, CSb and CSc found in the signature arrangements 208a, 208b and 208 borne by these data packages 206a, 206b and 206c. Each of these designated partitions then outputs a data package comprising their post-processed transaction data.

The acceleration node 202A then signs each of the data packages, output by the designated partitions of its processor arrangement, with the processing done on their content by the respective designated partition. These data packages 206c and 205a, bearing their signature, are broadcast across the system 200. Turning to acceleration node 202B, it outputs data packages 206a and 205b. As for acceleration node 202C, it outputs data packages 206b and 205c.

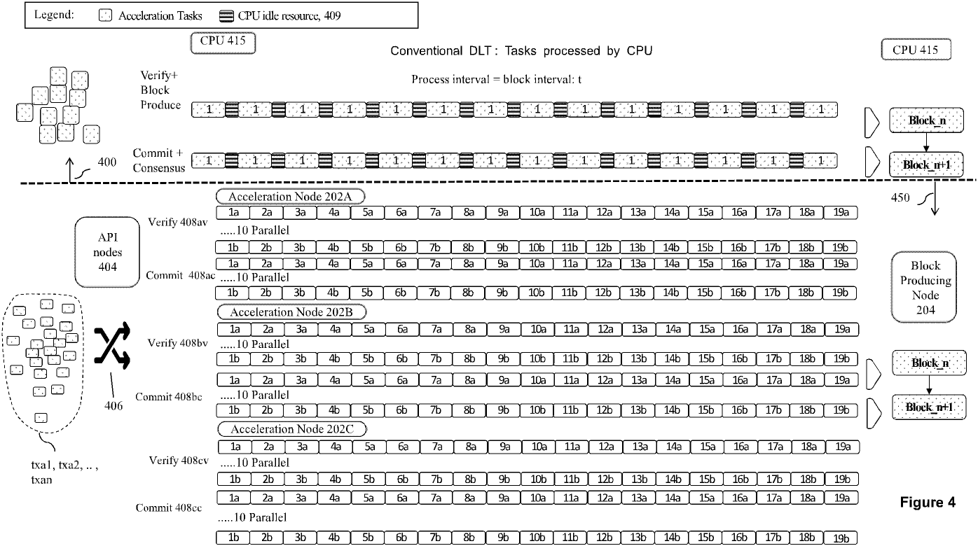

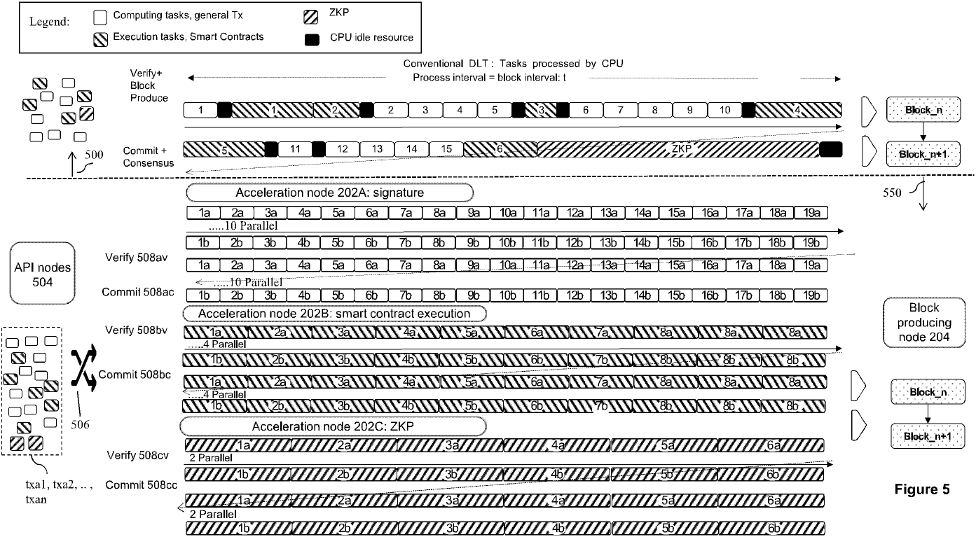

The use of parallel computing capability by the acceleration node 202A to organise received transaction data (txa1 to txa7) and assign the organised transaction data to designated partitions of its processor arrangement to process transaction data (txa1 to txa7) in two different scenarios is described below with respect to FIGS. 4 and 5. Hardware parallel execution is used to increase over-all transaction processing speed, therefore improve the system throughput. The processor architecture can be based on either FPGA, ASIC or GPU (graphic processing unit).

Portion 450 of FIG. 4 illustrates processing performed by the acceleration nodes 202A, 202B and 202C when seeking to authenticate digital signatures found in transaction data (txa1 to txan) received from the API nodes 404 to which they are connected. It will be appreciated that the “10 parallel” computing branches shown for each of the acceleration nodes 202A, 202B and 202C is for illustration purposes. The number of parallel computing branches that each acceleration node 202A, 202B and 202C possesses depends on each of their processing capability.

Each of the acceleration nodes 202A, 202B and 202C analyses their received transaction data (txa1 to txan) to determine which of them contain digital signatures. The transaction data that contains the digital signatures is assigned 406 to designated partitions of their respective processor arrangements configured to perform the required processing tasks that authenticate the digital signatures. With reference to FIG. 2, the assignment 406 results in the partition of the processor arrangement of the acceleration node 202A, designated to perform a verify task 408av, create the data package 205a with a verify signature VSa; and the partition of the processor arrangement of the acceleration node 202A, designated to perform a commit task 408ac, create the data package 206c with a commit signature CSa. Similarly, the assignment 406 results in the partition of the processor arrangement of the acceleration node 202B, designated to perform a verify task 408bv, create the data package 205b with a verify signature VSb; and the partition of the processor arrangement of the acceleration node 202B, designated to perform a commit task 408bc, create the data package 206a with a commit signature CSb. Turning to acceleration node 202C, the assignment 406 results in the partition of its processor arrangement designated to perform a verify task 408cv create the data package 205c with a verify signature VSc; and the partition of its processor arrangement designated to perform a commit task 408cc create the data package 206b with a commit signature CSc. The recording of the data packages 206a, 206b and 206c into a new data block is then performed by the block producing node 204 through consensus described above with respect to p.5 of FIG. 3.

In comparison, a conventional DLT (shown in portion 400) sees any one of its participating nodes perform the verify and commit tasks, the creation of a new data block and the performing of consensus to record the new data block. In addition to heavily taxing the computing capacity of a CPU 415 of the participating node, this also results in CPU idle time 409 as the CPU switches between the several roles it has to perform. The parallel approach undertaken by the acceleration nodes 202A, 202B and 202C thus alleviates processor strain experienced by the block producing node 204 and accelerates the process of the recording of a new data block.

Portion 550 of FIG. 5 illustrates processing performed by the acceleration nodes 202A, 202B and 202C when seeking to authenticate digital signatures, smart contract execution information and ZKP information found in transaction data (txa1 to txan) received from the API nodes 504 to which they are connected. It will be appreciated that the “10 parallel” computing branches shown for the acceleration node 202A, the “4 parallel” computing branches shown for acceleration node 202B; and the “2 parallel” computing branches for the acceleration node 202C is to illustrate that the number of parallel computing branches available decreases as the required computing resources increases. The number of parallel computing branches that each acceleration node 202A, 202B and 202C possesses depends on each of their processing capability.

Each of the acceleration nodes 202A, 202B and 202C analyses their received transaction data (txa1 to txan) to determine which of them contain digital signatures, smart contract execution information and ZKP information. For the sake of simplicity, FIG. 5 shows the data organisation occurring in the acceleration node 202A in respect of authenticating digital signatures in its received transaction data; the data organisation occurring in the acceleration node 202B in respect of authenticating smart contract information in its received transaction data; and the data organisation occurring in the acceleration node 202C in respect of authenticating ZKP information in its received transaction data. The data organisation occurring in the acceleration nodes 202A, 202B and 202C in respect of the other two types of data is not shown, i.e. smart contract execution information and ZKP information for the acceleration node 202A; digital signatures and ZKP information for the acceleration node 202B; and digital signatures and smart contract execution information for the acceleration node 202C.

In the acceleration node 202A, the transaction data that contains the digital signatures is assigned 506 to designated partitions of its processor arrangement configured to perform the required processing tasks that authenticate digital signatures. With reference to FIG. 2, the assignment 506 results in the partition of the processor arrangement of the acceleration node 202A, designated to perform a verify task 508av in respect of signatures, create the data package 205a with a verify signature VSa; and the partition of the processor arrangement of the acceleration node 202A, designated to perform a commit task 508ac in respect of signatures, create the data package 206c with a commit signature CSa.

Similarly, in the acceleration node 202B, the transaction data that contains the smart contract execution information is assigned 506 to designated partitions of its processor arrangement configured to perform the required processing tasks that authenticate smart contract execution information. With reference to FIG. 2, the assignment 506 results in the partition of the processor arrangement of the acceleration node 202B, designated to perform a verify task 508bv in respect of smart contract execution, create the data package 205b with a verify signature VSb; and the partition of the processor arrangement of the acceleration node 202B, designated to perform a commit task 508bc in respect of smart contract execution, create the data package 206a with a commit signature CSb.

Turning to acceleration node 202C, the transaction data that contains the ZKP information is assigned 506 to designated partitions of its processor arrangement configured to perform the required processing tasks that authenticate ZKP information. With reference to FIG. 2, the assignment 506 results in the partition of its processor arrangement, designated to perform a verify task 508cv in respect of ZKP information, create the data package 205c with a verify signature VSc; and the partition of its processor arrangement, designated to perform a commit task 508cc in respect of ZKP information, create the data package 206b with a commit signature CSc. The recording of the data packages 206a, 206b and 206c into a new data block is then performed by the block producing node 205 through consensus described above with respect to p.5 of FIG. 3.

In comparison, a conventional DLT (shown in portion 500) sees any one of its participating nodes perform the verify and commit tasks, the creation of a new data block and the performing of consensus to record the new data block. The CPU of the participating node switches between processing each of the different formats of data as they are received (e.g. general transactions, followed by smart contract execution). In addition to heavily taxing the computing capacity of the CPU of the participating node, this also results in CPU idle time 409 as the CPU switches between the several roles it has to perform. The parallel approach undertaken by the acceleration nodes 202A, 202B and 202C thus alleviates processor strain experienced by the block producing node 204 and accelerates the process of the recording of a new data block.

In another implementation (not shown), each of the acceleration nodes 202A, 202B and 202C may be designated to only process one type of transaction data. For example, the acceleration node 202A is configured to only process digital signatures, the acceleration node 202B is configured to only process smart contract execution data, while the acceleration node 202C is configured to only process ZKP data. Under BFT consensus, a total of nine acceleration nodes are then needed in the same network domain. A first group of three of the acceleration nodes, including acceleration node 202A, will be designated for digital signature verification. A second group of another three of the acceleration nodes, including acceleration node 202B, will be designated for smart contract execution. A third group of the remaining three acceleration nodes, including acceleration node 202C, will be designated for ZKP.

Operation of the acceleration nodes 202A, 202B and 202C in respect of their second feature of having one validate the verification results of another is described below.

Each of the acceleration nodes 202A, 202B and 202C has one unique key pair used for signing transaction data that it receives from API nodes and authenticates (refer FIGS. 4 and 5, which describes how the acceleration nodes 202A, 202B and 202C authenticate transaction data in respect of digital signatures, smart contract execution information and ZKP information, received from API nodes 404). This key pair is used by each acceleration node 202A, 202B or 202C to attach the verify signatures VSa, VSb and VSc into their generated data packages 205a, 205b and 205c shown in FIG. 2.

Each of the acceleration nodes 202A, 202B or 202C also perform two processes, known as: verify and commit. The outcome of these two processes is similar in that both result in applying a signature indicative of the acceleration node 202A, 202B or 202C that performed the verify process or commit process, so that a data package bearing a verify signature or both a verify signature and a commit signature reflects the acceleration node that has signed the data package. The difference lies in the source of the data on which the signatures are applied.

In the verify process: the transaction data that the acceleration node 202A, 202B or 202C is tasked to accelerate is received from API nodes to which the respective acceleration node 202A, 202B or 202C is connected (referring to FIG. 2, the acceleration node 202A is connected to API nodes a1, a2 and a3 while the acceleration node 202C is connected to API nodes c1 and c2). Output from the acceleration node 202A, 202B or 202C, as a result of a verify acceleration job, will contain a verify signature (VSa, VSb or VSc).

In the commit process: the transaction data that the acceleration node 202A, 202B or 202C is tasked to accelerate is received from another acceleration node 202A, 202B or 202C. The transaction data is extracted from a data package transmitted by the other acceleration node 202A, 202B or 202C (confer SubBlocka, SubBlockb and SubBlockc from the respective data packages 205a, 205b and 205c shown in FIG. 2). These data packages 205a, 205b and 205c already bear a verify signature applied by the acceleration node 202A, 202B or 202C that output the data package 205a, 205b or 205c (VSa, VSb or VSc). Output from the acceleration node 202A, 202B or 202C, as a result of a commit acceleration job, will contain a commit signature (CSa, CSb or CSc).

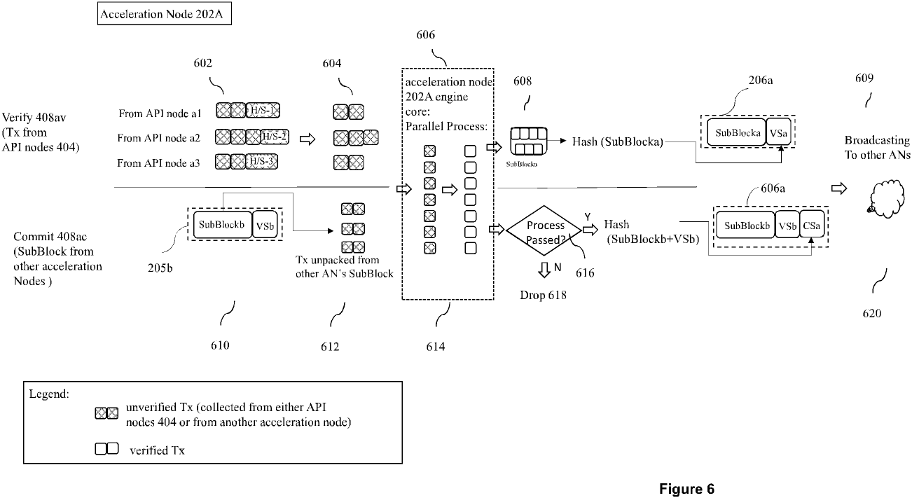

The verify and commit processes are described in greater detail with reference to FIG. 6, using acceleration node 202A as an example.

At stage 602, the acceleration node 202A receives transaction data from API nodes a1, a2 and a3 over which it is responsible. Each of the transaction data is appended with a hash digest or signature H/S-1, H/S-2 or H/S-3, generated by the respective API node a1, a2 or a3. The acceleration node 202A verifies the source of the received transaction data by checking the hash digest or signature H/S-1, H/S-2 or H/S-3. Checking the hash digest or signature H/S-1, H/S-2 or H/S-3 also reveals whether there is delivery integrity, i.e. whether the transaction data is immutable and possesses undeniability of sender identity. The source of the received transaction data is verified by a verification partition of the processor arrangement of the acceleration node 202A designated to perform a verify task 408av.

At stage 604, the hash digest or signature H/S-1, H/S-2 or H/S-3 is dropped after the source of the received transaction data is verified.

At stage 606, the integrity of the transaction data is verified by processing each of the individual transactions in the transaction data to determine their validity. Examples of the processing done include whether the attributes and content of the transaction data is correct. Recapping FIGS. 3, 4 and 5, the processing includes verifying whether the transaction data is immutable and undeniability of sender identity. In addition, concurrence of the transaction data with a DLT record may be used to validating the accuracy of the transaction data. The parallel processing that occurs in stage 606 for this verification is described in FIGS. 4 and 5 and is thus not further elaborated.

At stage 608, all transaction data whose integrity is successfully established in stage 606 is consolidated into a data package SubBlocka. The acceleration node 202A generates a verify signature VSa that serves to establish the integrity of the transaction data. The verify signature VSa is generated by hashing the content of SubBlocka, i.e. HASH (SubBlockb) ➔ VSa. The verification partition of the processor arrangement of the acceleration node 202A then broadcasts, at stage 609, the data package 206a with the verify signature VSa.

At stage 610, the acceleration node 202A receives a data package from another acceleration node in the system, such as the data package 205b that is output by the acceleration node 202B. The data package 205b contains the verify signature VSb establishing the integrity of its transaction data. A commitment partition of the processor arrangement of the acceleration node 202A designated to perform a commit task 408ac then seeks to validate the verify signature VSb as follows. That is, the acceleration node 202A seeks to validate the work done by the acceleration node 202B.

At stage 612, transaction data in SubBlockb is extracted. The extracted transaction data is then processed at stage 614. The parallel processing that occurs in stage 614 is described in FIGS. 4 and 5 and is thus not further elaborated. At stage 614, several checks are performed, amongst which include: i) whether enough signatures are gathered on the data package 205b like the verify signature VSb being indeed present, another verify signature (such as VSc) being present or a commit signature (CSb, CSc) being present; and ii) cross checking the results of another acceleration node (e.g. 202B or 202C) in respect of data immutability and sender identity, accuracy of transaction data content. If the extracted transaction data fails these checks, then the data package 205b is discarded 618. If the extracted transaction data passes 616 these checks, a commit signature CSa is then generated to indicate that the verify signature VSb is validated. The commit signature CSa is generated by hashing SubBlockb and all signatures present in the data package 205b, i.e. HASH (SubBlockb + VSb) ➔ CSa. The commitment partition of the processor arrangement of the acceleration node 202A then broadcasts, at stage 620, data package 606a bearing both the verify signature VSb and the commit signature CSa.

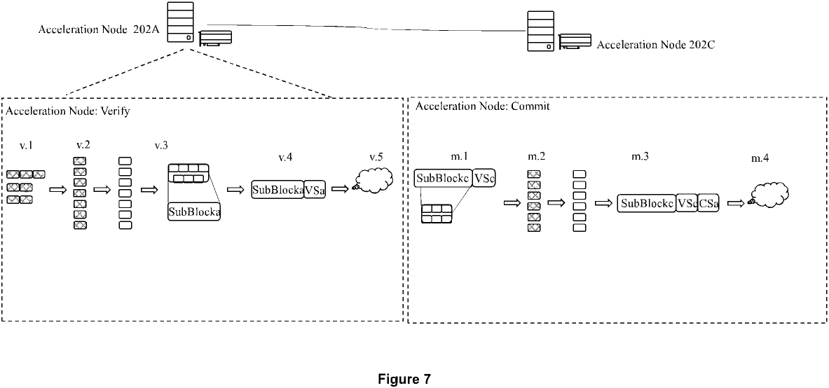

The commit process that the acceleration node 202A performs with another acceleration node in the system 200, such as the acceleration node 202C, is identical. FIG. 7 shows the verify process performed by the acceleration node 202A; and the commit process performed between the acceleration node 202A and the acceleration node 202C.

In FIG. 7, the acceleration node 202A performs a verify process as follows.

At stage v.1, the acceleration node 202A receives raw transaction data from API nodes connected thereto. At stage v2, the acceleration node 202A uses parallel processing to verify the received transaction data. The verified transaction data is then packaged into SubBlocka at stage v.3. At stage v.4, the acceleration node 202A generates a verify signature VSa for applying onto a data package containing SubBlocka. At stage v.5, the acceleration node 202A broadcasts the data package, with its verify signature VSa, to other acceleration nodes in the system.

The acceleration node 202A validates the verify signature VSc in a data package received from the acceleration node 202C as follows.

At stage m.1, the acceleration node 202A unpackages all transaction data from SubBlockc in the data package received from the acceleration node 202C. At stage m.2, the acceleration node 202A uses parallel processing to check whether the SubBlockc has sufficient verify signatures. If there are sufficient verify signatures, the acceleration node 202A generates a commit signature CSa and appends it onto a data package containing SubBlockc and the verify signature VSc. At stage m.4, the acceleration node 202A broadcasts the data package, with its verify signature VSc and commit signature CSa, to other acceleration nodes in the system.

From the above description spanning FIGS. 4 to 7, it will be appreciated that the two features of the acceleration nodes 202A, 202B and 202C, namely its parallel computing capability and one acceleration node validating the verify signature generated by another acceleration node, are intertwined. The validation of the verify signature uses the parallel computing capability of the acceleration node. It will also be appreciated that while the operation of the acceleration nodes 202A, 202B and 202C results in consecutively signed data packages 206a, 206b, 206c, with each having two signatures (the first being the verify signature and the second being the commit signature), it is possible that a consecutively signed data package can have more than two signatures.

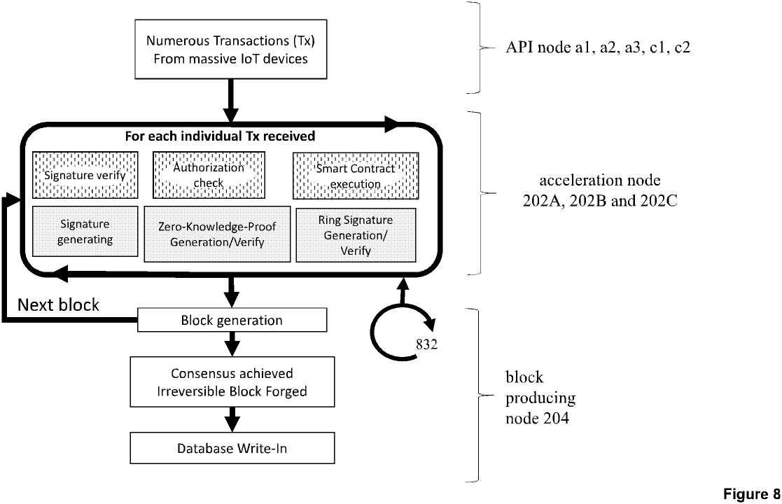

FIG. 8 shows a schematic summarising the functions that the API nodes a1, a2, a3, c1 and c2; the acceleration nodes 202A, 202B and 202C; and the block producing node 204 shown in FIG. 2 perform in creating a new data block in a distributed ledger.

The API nodes a1, a2, a3, c1 and c2 collect the transaction data from numerous IOT device that is to be recorded into a new data block in the distributed ledger.

Instead of having all tasks related to recording a new data block into a distributed ledger by the block producing node 204, the acceleration nodes 202A, 202B and 202C distribute these tasks by taking on a portion of the processing work required to record the new data block into the distributed ledger. The tasks that the acceleration nodes 202A, 202B and 202C take on for each transaction in the transaction data received from the API nodes a1, a2, a3, c1 and c2 include: one of the acceleration nodes signing data packages whose content is checked, and then having another one of the acceleration nodes validate the signed data package; authorisation check; smart contract execution; the generation and verification of ZKP; and the generation and verification of ring signatures.

Parallel computing capability is harnessed by the acceleration nodes 202A, 202B and 202C to perform their tasks. The validation of signed data packages, smart contract execution; and the verification of ZKP has already been described above. Authorisation check refers to the check performed when an account for a digital wallet address, shared by multiple users, is accessed. Each of these users has different authorisation levels; some have authority to do token transactions and some can only check the balance. The authorisation check may be offloaded to the parallel processing capability of the acceleration nodes 202A, 202B and 202C. Ring signatures refer to privacy protection techniques which employ signatures that do not reveal the party who signed the message, where the signature is only valid to its intended recipient. The processing of transactions that use such ring signatures may be offloaded to the parallel processing capability of the acceleration nodes 202A, 202B and 202C.

The block producing nodes 204 in the system then only need to check whether there is consensus amongst them with regard to the data block that is generated by the acceleration nodes 202A, 202B and 202C for entry into the distributed ledger. If consensus is achieved, the data block is written into the distributed ledger.

The acceleration nodes 202A, 202B and 202C are also configured to receive 832 a software update; and modify their operation protocol in accordance with the received software update. This allows all applications running in the acceleration nodes 202A, 202B and 202C to be dynamically allocated and upgraded.

In contrast, traditional FPGA service is programmed through a firmware download, not a software upgrade. The limitation of remotely upgrading firmware (e.g. from ver 1.0 to ver 1.1) is that it is difficult to change the function for which the FPGA is programmed to perform. As such, if the FPGA has been programmed for signature verification, re-programming it for ZKP verification is difficult through a remote upgrade. Operator intervention and access is required. A general upgrade is also complex, requires special tools and may take several hours. After the upgrade, the server in which the FPGA is installed requires rebooting.

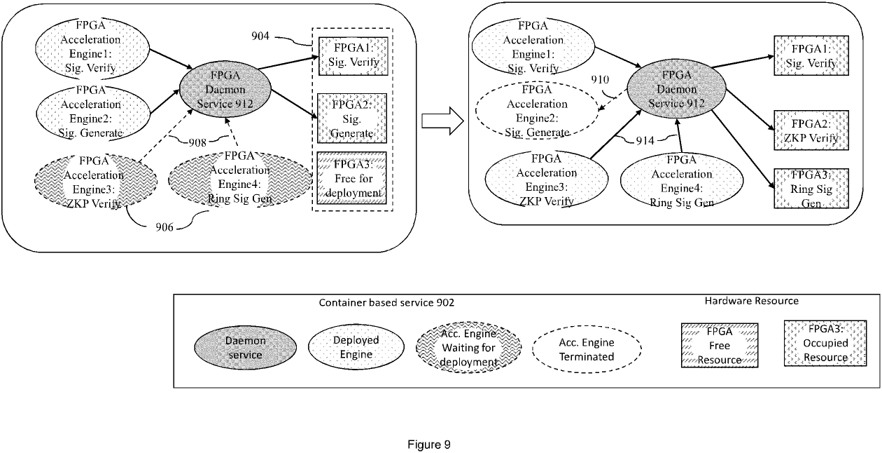

FIG. 9 illustrates a container based service 902, which provides a standalone, executable package of software that includes everything needed to upgrade or reprogram an acceleration node, such as: code, runtime, system tools, system libraries and settings. That is, all services will run from containers based upon FPGA, instead of directly on the FPGA. The container 902 allows dynamic allocation and upgrading of the acceleration engine running inside each acceleration node. Example capabilities of the container 902 include:
1). Virtualizing the FPGA hardware (HW) resource. The container 902 deploys on a network level and not on at physical machine level, which means multiple servers with multiple FPGAs are unifiable as a common computing resource;
2). Update/change acceleration engine dynamically and deploy into HW resource. The container 902 services can themselves be updated to change their provided functionality and provide a different acceleration engine. Deployment of the container 902 is similar to a software installation, with no operator intervention and access required. Stopping or rebooting of the server may not be required. The updated acceleration engine operates shortly (an interval of minutes) after installation.

The deployment of a container based service 902 is described with a use case below, having a total of three FPGA HW resources 904 available in a cluster. Two are already deployed (FPGA1, FPGA2), one (FPGA3) is free for deployment. Two acceleration engines 906 need to be deployed, so that two FPGA resources need to be freed, whereby the freed FPGA resource and the already available FPGA3 HW resource can accommodate the deployment of both acceleration engines 906.

The OSS/BSS management console 110 (refer FIG. 1) can be accessed to request for deploying 908 FPGA acceleration engine3 and FPGA acceleration engine4. To obtain two available FPGA HW resources, an arbitrary withdrawal decision may be made, such as the termination 910 of the signature generation engine from FPGA2. Alternatively, one more FPGA HW resource may be deployed (not shown).

FPGA Daemon service 912 terminates the signature generation engine from FPGA2, releasing the FPGA2 HW resource. The FPGA Daemon service 912 then deploys 914 the two new FPGA acceleration engines (ZKP verify and ring signature generation) onto FPGA2 and FPGA3 respectively.

FPGA Daemon service 912 is also responsible for maintaining all services that are deployed to FPGA1, FPGA2, and FPGA3. In case any service failure happens, FPGA Daemon 912 terminates and re-establish the affected service immediately, ensuring system robustness.

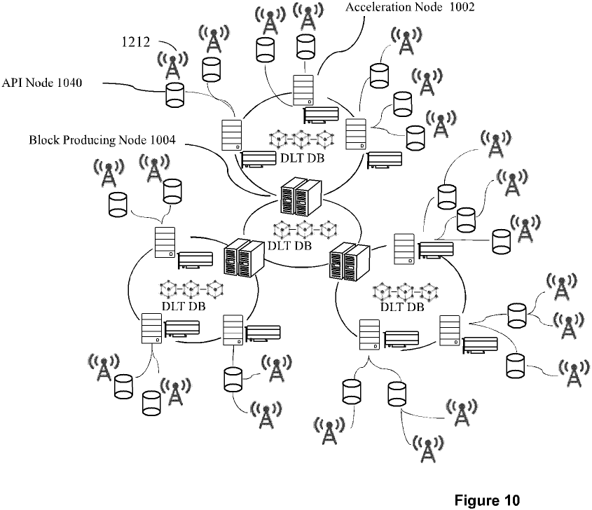

FIG. 10 shows the system 200 of FIG. 2 being deployed in accordance with BFT (Byzantine Fault Tolerance). The acceleration nodes 1002 and the block producer nodes 1004 are deployed in multiples of three. However, no such limitation is placed on the API nodes 1040. Each of the API nodes 1040 is deployed in a local data centre, in proximity to a 5G radio access point 1212. The radio access point 1212 acts as an interface between all mobile terminals and a MNO network. IOT devices utilise the infrastructure of the MNO network when they are used in transactions that result in transaction data that is to be recorded by the block producer nodes 1004.

From the above discussion with respect to FIGS. 1 to 10, mobile operators can accelerate performance in verifying transactions on the DLT. This brings services to mission-critical devices (eg: Manufacturing robotics, Autonomous vehicles) and enhances “Quality of Experience” through reduced latency. A set of defined protocols instruct workloads to be shared between the CPU (built for general purpose) and the FPGA (built for intensive tasks) processor that utilises both processors at the same time. When IoT devices with embedded eSIMs initiate a transaction or smart contract via the DLT (through MEC node consensus), the transaction or contracts that are processed can be directed to the FPGA (installed in the acceleration nodes) for smooth acceleration, thereby improving overall performance.

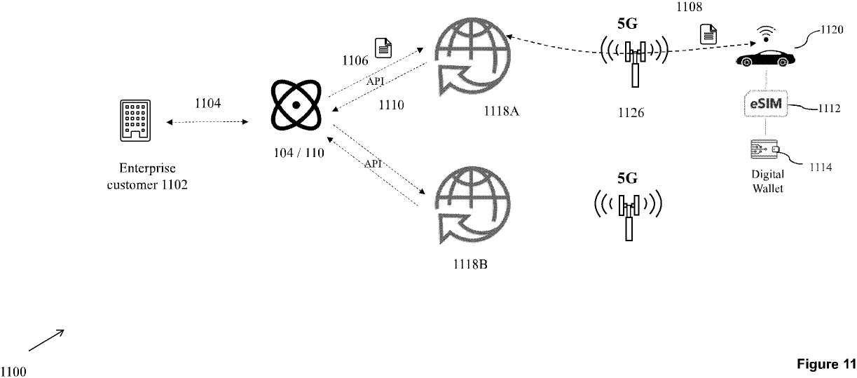

FIG. 11 is a schematic providing an overview of the SaaS management console 104 and the OSS/BSS management console 110 described in FIG. 1 facilitating the deployment of an electronic subscriber identity module (eSIM) 1112 to work with different mobile network operators (MNO). For the sake of simplicity, only two MNOs 1118A and 1118B are shown.

An enterprise customer 1102 accesses 1104 their SaaS management console 104 to select either the MNO 1118A or MNO 1118B through their respective OSS/BSS management console 110 to change the profile of an IOT device 1120 at the end of a command chain.

The respective OSS/BSS management console 110 sends 1106 a changed eSIM profile with an API to the MNO A 1118A. The MNO 1118A then pushes 1108 the changed profile to the IOT device 1120 via 5G network 1126. The profile of the eSIM 1112 is then configured to operate in accordance with the MNO 1118A data plan and billing charged to a digital wallet 1114 that configured for use with the MNO 1118A. The update of the eSIM 1112 profile is reflected 1110 back to the enterprise customer 1102 through their SaaS management console 104.

The eSIM 1112 is a secure element found in IoT devices that brings: (1) operational flexibility (2) enhanced scalability and (3) security for identity management. Operation of an eSIM is defined by the GSMA specification with a MNO PKI (public key infrastructure) system support.

In FIG. 11, the eSIM 1112 is harnessed to host a digital wallet 1114 for the IOT device 1120, in addition to allowing the IOT device 1120 to connect onto the MNO 1118A and 1118B 5G network.

The eSIM 1112 has the capability of storing key pairs comprising a set of public and private keys allowing it to interact with a DLT distributed ledger (such as the distributed ledger 102 described in FIG. 1) and performing digital signatures when making token exchanges. This allows the IOT device 1120 to pay and receive tokens.

The eSIM 1112 in the IoT device 1120 creates Machine-2-Machine transactions which can be processed via the DLT deployed inside a MEC node through its 5G connectivity. The DLT would be able to (1) identify device ID through the eSIM (2) execute smart contracts and (3) verify token payment transactions. Further detail on the provisioning of the eSIM 1112 to perform these three functions is described below.

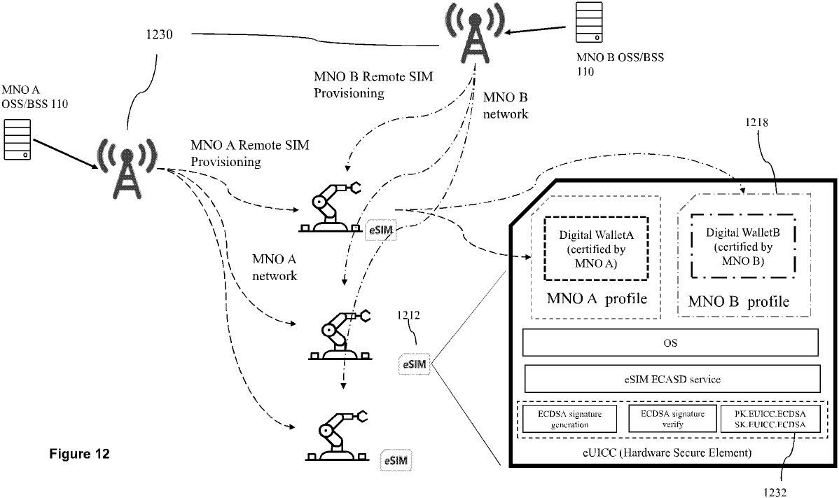

FIG. 12 shows a service deployment server 1230 that is used to remotely configure an eSIM 1212 that is embedded in an IOT device and provision the eSIM 1212 with digital wallet capability and digital signature 1232 capability to authenticate transactions performed using the digital wallet through a generated digital signature. FIG. 12 shows that each of the MNO A and MNO B has its dedicated service deployment server 1230 through which it provisions the eSIM 1212 with a profile 1218 that supports communication protocol that is used by the MNO A and MNO B respectively.

Each profile 1218 stored in the eSIM 1212 is updated through remote provisioning effected by the service deployment server 1230. Such an update may occur at any moment when the eSIM 212 is active and connected to the MNO A or MNO B network. This provides the IOT device with multiple MNO capability (multiple eSIM profiles) which makes device roaming and device sharing/lease possible.

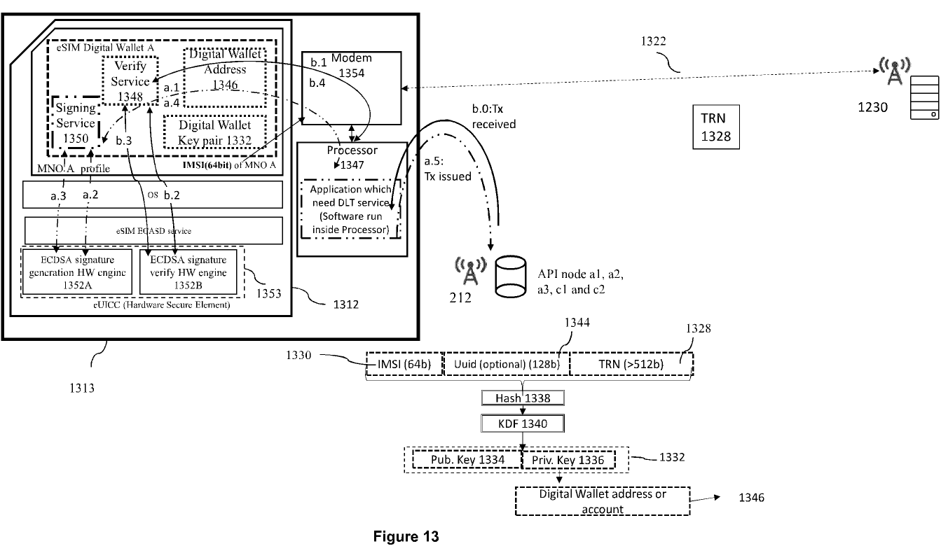

FIG. 13 shows a sequence of stages that occur when provisioning a secure element 1312, on which the eSIM resides, using a service deployment server 1230 that belongs to MNO A. It will be appreciated that such a sequence of stages will also occur for the MNO B or any other mobile network operator.

To enhance security of transactions that occur over the MNO network, a parameter that is unique to the MNO A is used to base digital signatures that authenticate such transactions. This parameter is a subscriber identity used to identify a wireless device 1313, in which the secure element 1312 is deployed, to the mobile network operator (MNO A) network. The subscriber identity 1330 is an IMSI (International Mobile Subscriber Identity), which is a global 64bit unique number and allocated by the MNO).

During initialisation, the service deployment server 1230 transmits, over data channel 1322, a set of instructions that can program the secure element 1312 of the wireless device 1313. The set of instructions may, for example, be contained in a software package and get executed upon installation of the software package. In such an implementation, it is the software package that is transmitted by the service deployment server 1230 to the wireless device 1313 during initialisation. The transmitted instructions from the service deployment server 1230, when executed in the wireless device 1313, configure the wireless device 1313 to store a key pair 1332, based on the subscriber identity, in the secure element 1312 of the wireless device 1313. The stored key pair 1332 forms part of the profile for the mobile network operator (MNO A), where the stored key pair 1332 may be used by an applet for a digital wallet. Using the IMSI to generate the key pair has the advantage of leveraging the MNO’s KYC (know your client) protocol to enhance security control.

In one implementation, the stored key pair 1332 is obtained from the service deployment server 1230. That is, storage occurs after the transmitted instructions from the service deployment server 1230, when executed in the wireless device 1313, further configures the wireless device 1313 to obtain the key pair 1332 from the service deployment server 1230 over the data channel 1322.

In another implementation, the stored key pair 1332 results from the wireless device 1313 being configured to, following execution of the transmitted instructions from the service deployment server 1230, obtain from the service deployment server 1230, the subscriber identity 1330 used to identify the wireless device 1313 to the mobile network operator (MNO A) network. The key pair 1332 is generated based on the received subscriber identity 1330 and then stored.

The private key 1336 is used to generate a signature for use with outgoing data (i.e. data for transmission). In one implementation, the public key 1334 may be broadcast by the wireless device 1313 for signature verification of the transmitted data that bears the signature generated by the private key 1336. The public key 1334 may be accompanied by a certificate verified by a certificate authority to authenticate that the transmitted data is sent by the owner of the certificate. In another implementation, the public key 1334 may be included in the transmitted data, where it is recovered by an acceleration node (e.g. acceleration nodes 202A, 202B and 202C shown in FIG. 2) through a suitable algorithm, as part of the signature verification process.

The transmitted instructions from the service deployment server 1230 also configure the wireless device 1313 to include further parameters when generating the key pair 1332.

A first further parameter is random number 1328 to randomise the key pair 1332 based on the subscriber identity 1330. In one implementation, the random number 1328 is a TRN (True Random Number) obtained from the service deployment server 1230, being a completely randomized number having length of at least 256 bits. The TRN may only be used once and erased permanently at the wireless device 1313 end after the key pair 1332 is generated to reduce the possibility of comprising a digital wallet based on the key pair 1332. However, the TRN may be retained in the service deployment server 1230 for the key pair 1332 recovery. In other implementations, the random number 1328 may be generated by the wireless device 1313. If so, the random number 1328 may still be erased permanently at the wireless device 1313 end after the key pair 1332 is generated. However, the random number 1328 may then be transmitted to the service deployment server 1230 for storage and use, for example for the key pair 1332 recovery.

A second further parameter that is included when generating the key pair 1332 is an identifier 1344 of a hardware component of the wireless device 1313. The hardware component from which the wireless device 1313 derives the identifier 1344 may include any part that provides a UUID (universally unique identifier), such as a semiconductor device (CPU/MCU) which includes a processor 1347 that manages the secure element 1312.

The transmitted instructions from the service deployment server 1230, when executed in a wireless device 1313, may configure the wireless device 1313 to perform any one or more a hash function 1338 and a key derivation function (KDF) 1340 to generate the key pair 1332. The hash function 1338 generates a fixed length “digest” from input data, while the KDF 1340 is a cryptographic function for generating keys from a random number.

The transmitted instructions from the service deployment server 1230, when executed in a wireless device 1313, may further configure the secure element of the wireless device 1313 to store a plurality of profiles, each for a different mobile network operator. Each of these profiles store network configuration data that allows tapping into a data plan that the wireless device 1313 has with each of the different mobile network operators, with FIG. 13 showing the profile for the MNO A.

The transmitted instructions from the service deployment server 1230, when executed in a wireless device 1313, may further configure the secure element of the wireless device 1313 to: host an electronic wallet (via eSIM) for processing payment tokens used in transactions facilitated by the mobile network operator. These payment tokens may be generated by a distributed ledger, such as the DLT 102 shown in FIG. 2. The address 1346 for the electronic wallet in the secure element 1312 is determined by the public key 1334 of the key pair 1332. The distributed ledger DLT 102 will be updated with a new data block that records data from one or more transactions performed using the electronic wallet. The recording of the new data block entails the acceleration described in FIGS. 4 and 5, which produces a signature arrangement for a data package that contains this transaction data; followed by consensus being present when the signature arrangement is validated, as described in FIG. 3. With multiple digital wallets, device roaming is made possible through selecting one of the digital wallets to perform a payment transaction, which results in the selected mobile network operator (e.g. MNO A or MNO B shown in FIG. 12) facilitating the payment transaction.

Partitions in the secure element 1312 will also be established to perform a verify service 1348 and a signing service 1350 after the secure element 1312 is initialised. The verify service 1348 and the signing service 1350 are part of the MNO A profile, which may be used by an applet. The verify service 1348 is called when the wireless device 1313 receives data which requires verification, while the signing service 1350 is called when the wireless device 1313 issues data from transactions performed with the wireless device 1313 (e.g. payment at a toll station).

With reference to FIG. 2, the key pair 1332 provisioned by the service deployment server 1230 can be used by one or more embedded algorithm engines 1353 for transactions occurring at a factory 250, a toll station 252 and a charging station 254. For instance, an ECDSA algorithm based signature generation HW engine 1352A (being one of the embedded algorithm engines 1353) may use the private key 1336 to sign outgoing data from the wireless device 1313 that is in respect of such transactions. The API node a1, a2, a3, c1 or c2 which is in communication with the wireless device 1313 receives the signed transaction data.

A use case for the embedded algorithm engine 1353 is as follows, where a DLT application (that, for example, uses the digital wallet) running in the wireless device 1313 communicates with one of the API nodes a1, a2, a3, c1 or c2 to perform a transaction. At stage a.1, the DLT application calls the signing service 1350, an applet residing in the secure element 1312, that a transaction message is to be transmitted. At stage a.2, the signing service 1350 calls the ECDSA algorithm based signature generation HW engine (1352A) to use the private key 1336 to generate a signature. At stage aX.3, the signing service 1350 receives the signature from the ECDSA algorithm based signature generation HW engine (1352A). At stage a.4, the signing service 1350 returns the generated signature to the DLT application. At final stage a.5, the DLT application sends the message bearing the signature, over the air, to the API node a1, a2, a3, c1 or c2 with which the DLT application is in communication.

The wireless device 1313 receives a transaction message (Tx) at stage b.0. If the transaction requires verification, the DLT application calls verify service 1348 at stage b.1. At stages b.2 and b.3, the verify service 1348 uses the ECDSA algorithm based signature verify HW engine 1352B to verify the transaction. At stage b.4, the verification result is returned to the DLT application.

As an alternative to having the service deployment server 1230 remotely configure the secure element 1312, a computer-readable, non-transitory medium present in a remote server (not shown) may contain a computer program that when executed causes the processor 1347 of the wireless device 1313 to store a key pair 1332, based on a subscriber identity used to identify the wireless device 1313 to a mobile network operator network, in the secure element 1312 of the wireless device 1313. The computer program also causes the processor 1347 to generate a signature, using a private key 1336 of the key pair 1332, for use with outgoing data for transmission. The computer-readable, non-transitory medium in the remote server may be accessed, for example, when the wireless device 1313 accesses a library (such as an application store) to download the computer program. Alternatively, a computer-readable, non-transitory medium within the wireless device 1313 may already store the computer program, ready for installation when required.

In the application, unless specified otherwise, the terms “comprising”, “comprise”, and grammatical variants thereof, intended to represent “open” or “inclusive” language such that they include recited elements but also permit inclusion of additional, non-explicitly recited elements. It will also be appreciated that the terms “information” and “data” are used interchangeably, especially when referring to recording transactions into a distributed ledger.

While this invention has been described with reference to exemplary embodiments, it will be understood by those skilled in the art that various changes can be made and equivalents may be substituted for elements thereof, without departing from the spirit and scope of the invention. In addition, modification may be made to adapt the teachings of the invention to particular situations and materials, without departing from the essential scope of the invention. Thus, the invention is not limited to the particular examples that are disclosed in this specification, but encompasses all embodiments falling within the scope of the appended claims.

1. A system for supporting services that use a distributed ledger to record transaction data, the system comprising
a block producing node comprising a processor arrangement configured to record a new data block into the distributed ledger, the processor arrangement configured to execute computer-readable program code to:
receive a data package comprising transaction data for recording into a new data block of the distributed ledger, the data package bearing a signature arrangement, the signature arrangement being performed externally;
validate the signature arrangement of the received data package;
determine whether consensus is present through a sufficient number of other block producing nodes in the system having also received the data package and validated its signature arrangement; and
record the transaction data from the received data package into a new data block of the distributed ledger, in response to confirmation of the consensus being present.

2. The system of claim 1, wherein the signature arrangement borne by the data package results from the transaction data having being consecutively signed, with each signature being performed by a different external node.

3. The system of claim 2, wherein when validating the certificate signature arrangement of the received data package, the processor arrangement of the block producing node is further configured to determine presence of a sufficient number of the signatures.

4. The system of claim 3, wherein when recording a new data block into the distributed ledger, the processor arrangement of the block producing node is further configured to include a hash digest of transaction data from a last data package.

5. The system of claim 4, the system further comprising
an acceleration node comprising a processor arrangement configured to format transaction data for recording as a new data block into the distributed ledger, the processor arrangement configured to execute computer-readable program code to:
organise received transaction data according to tasks required to process them;
assign the organised transaction data to a designated partition of the processor arrangement configured to execute steps that are required to perform the required processing tasks, wherein each of the designated partitions is configured to create a data package comprising the processed transaction data;
sign each of the data packages with the processing done on their transaction data; and
broadcast the data packages bearing their signature across the system.

6. The system of claim 5, wherein one of the designated partitions of the processor arrangement of the acceleration node is a verification partition configured to
verify the integrity of the received transaction data; and
generate a verify signature to establish the integrity of the received transaction data for the data package created by the verify partition, in response to successful verification of the integrity of the received transaction data.

7. The system of claim 6, wherein the processor arrangement of the acceleration node is further configured to discard the data package containing the transaction data that lack integrity; and wherein when verifying the integrity of the received transaction data, the processor arrangement of the acceleration node is further configured to determine whether the received transaction data has delivery integrity; and a source of the transaction data.

8. (canceled)

9. The system of claim 7, wherein one of the designated partitions of the processor arrangement of the acceleration node is a commitment partition configured to
validate a verify signature found in a data package received from another acceleration node in the system, the verify signature establishing the integrity of that transaction data in the received data package; and
generate, in response to successful validation, a commit signature indicative that the verify signature is validated, wherein the data package created by the commitment partition further comprises the verify signature from the received data package.

10. The system of claim 9, wherein the processor arrangement of the acceleration node is further configured to discard the data package having a verify signature that fails the validation.

11. The system of claim 10, wherein the designated partitions of the processor arrangement process their assigned transaction data in parallel.

12. The system of claim 11, wherein the processor arrangement of the acceleration node is further configured to:
receive a software update;
modify its operation protocol in accordance with the received software update; and wherein the software update reprograms one or more of the partitions of the processor arrangement of the acceleration node to process different tasks.

13. (canceled)

14. The system of claim 12, wherein the processor arrangement of the block producing node is further configured to:
support one or more consoles that host commands that manage operation of the distributed ledger; and
wherein the system further comprises:
a management node comprising a processor arrangement, the processor arrangement configured to execute computer-readable program code to:
support one or more consoles that host commands that manage operation of the distributed ledger; and
transmit the commands to the block producing node for execution.

15. (canceled)

16. The system of claim 14, wherein the transaction data comprises any one or more of data related to: digital signatures, smart contract execution and zero knowledge proof.

17. The system of claim 16, wherein the acceleration node is deployed in a server equipment room or an edge data centre, central office, regional data centre or global data centre.

18. The system of claim 16, wherein the block producing node is located in an edge data center, central office, regional data centre or global data centre.

19. A wireless device for use in a cellular communication network, the wireless device comprising:
a transceiver;
a secure element; and
a processor in communication with the transceiver and the secure element, the processor configured to:
store a key pair, based on a subscriber identity used to identify the wireless device to a mobile network operator network, in a secure element;
generate a signature, using a private key of the key pair, for use with outgoing data; and
transmit, via the transceiver, the outgoing data bearing the signature.

20. The wireless device of claim 19, wherein the processor is further configured to:
obtain the key pair from the mobile network operator network;
include a random number and an identifier of a hardware component of the wireless device when generating the key pair;
perform any one or more a hash function and a key derivation function to generate the key pair;
wherein the stored key pair results from the processor being further configured to:
obtain, from the mobile network operator network, the subscriber identity used to identify the wireless device to the mobile network operator network; and
generate the key pair based on the received subscriber identity; and
wherein the random number is obtained from the mobile network operator network.

21. (canceled)

22. (canceled)

23. (canceled)

24. (canceled)

25. The wireless device of claim 20, where in the secure element stores a plurality of profiles, each for a different mobile network operator.

26. The wireless device of claim 25, the secure element further hosting an electronic wallet for processing payment tokens used in transactions facilitated by the mobile network operator; and wherein the address for the electronic wallet in the secure element is determined by a public key of the key pair.

27. (canceled)

28. The wireless device of claim 20, wherein the received data and the transmitted data comprises any one or more of data that facilitates identification of the wireless device, smart contract execution and verification of payment transactions.

29. The wireless device of claim 28, wherein the signature is generated by an algorithm engine embedded in the secure element for data in respect of a transaction performed by the wireless device.

30. The wireless device of claim 29, wherein the transaction is effected by a distributed ledger application running in the wireless device.

31. The wireless device of claim 30, wherein the wireless device is further configured to broadcast a public key of the key pair or include the public key in outgoing data bearing the signature.

32. A service deployment server configured to transmit instructions, that when executed in a wireless device, configure the wireless device to:
store a key pair, based on a subscriber identity used to identify the wireless device to a mobile network operator network, in a secure element of the wireless device; and
generate a signature, using a private key of the key pair, for use with outgoing data for transmission.

33. The service deployment server of claim 32, wherein the stored key pair is obtained from the service deployment server.

34. The service deployment server of claim 32, wherein the stored key pair results from the wireless device being configured to, following execution of the transmitted instructions:
obtain, from the mobile network operator network, the subscriber identity used to identify the wireless device to the mobile network operator network; and
generate the key pair based on the received subscriber identity.

35. The service deployment server of claim 34, wherein the transmitted instructions, when executed in a wireless device, further configure the wireless device to: include a random number and an identifier of a hardware component of the service deployment server when generating the key pair.

36. The service deployment server of claim 35, wherein the random number is obtained from the service deployment server; wherein the wireless device is further configured to perform any one or more of a hash function and a key derivation function to generate the key pair.

37. (canceled)

38. The service deployment server of claim 36, wherein the transmitted instructions, when executed in a wireless device, further configure the secure element of the wireless device to store a plurality of profiles, each for a different mobile network operator.

39. The service deployment server of claim 38, wherein the transmitted instructions, when executed in a wireless device, further configure the secure element of the wireless device to: host an electronic wallet for processing payment tokens used in transactions facilitated by the mobile network operator; wherein the address for the electronic wallet in the secure element is determined by a public key of the key pair.

40. (canceled)

41. The service deployment server of claim 39, wherein the transmitted instructions, when executed in a wireless device, further configure the wireless device to broadcast a public key of the key pair or embed the public key in outgoing data bearing the signature.

42. A computer-readable, non-transitory medium storing a computer program, wherein said computer program causes a processor to execute:
storing a key pair, based on a subscriber identity used to identify the wireless device to a mobile network operator network, in a secure element of the wireless device; and
generate a signature, using a private key of the key pair, for use with outgoing data for transmission.
